(19) United States
(12) Patent Application Publication
(10) Pub. No.: US 2010/0156308 A1
(43) Pub. Date: Jun. 24, 2010

(54) ADJUSTABLE OUTPUT BALLAST FOR POWERING BOTH FLUORESCENT LAMPS AND LED LAMPS

(76) Inventors: Minoru Maehara, Osaka (JP); Akinori Hiramatsu, Nara (JP); Masaki Kobayashi, Osaka (JP)

Correspondence Address: WADDEY & PATTERSON, P.C., 1600 DIVISION STREET, SUITE 500, NASHVILLE, TN, 37203, US

(21) Appl. No.: 12/637,080

(22) Filed: Dec. 14, 2009

(30) Foreign Application Priority Data
Dec. 12, 2008 (JP) 2008-317730

(51) Int. Cl. H05B 41/36

(52) U.S. Cl. 315/224

(57) ABSTRACT

A ballast is provided for powering either of a fluorescent lamp or an LED lamp. The ballast includes a power supply and a pair of switching elements connected in series and coupled across an output end of the power supply. A voltage is provided across a pair of lamp output terminals coupled to the switching elements during a predetermined time period after startup of the ballast. A current condition is detected across the pair of lamp output terminals during the predetermined time period. Based on the detected current condition, the presence of a fluorescent lamp or an LED lamp connected to the ballast may be determined, and either of a first or second voltage output is provided across the lamp output terminals suitable for powering the appropriate lamp after lapsing of the predetermined time period.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### CROSS-REFERENCES TO RELATED APPLICATIONS

This application claims benefit of the following patent application(s) which is/are hereby incorporated by reference: Japan Patent Application No. 2008-317730, filed Dec. 12, 2008.

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

The present invention relates generally to electronic ballast for powering either of a fluorescent lamp or a fluorescent LED lamp, and a lighting fixture using the same. More particularly, the present invention relates to an electronic ballast configured to detect the presence of a particular lamp and to adjust an output voltage to properly power the detected lamp while preventing damage to the lamp during the detection process.

Typically, a fluorescent LED lamp configured for installation in a conventional fluorescent lighting fixture includes a plurality of LED's mounted on a substrate and connected between lamp electrodes. LED lamps are desirable for their lower energy consumption and relatively long lamp life, and manufacturers would often prefer to attach an LED lamp rather than a standard fluorescent lamp tube to a conventional fluorescent lighting fixture. However, conventional fluorescent LED lamps are often incompatible with an inverter-type lighting fixture rated for fluorescent lamps. This incompatibility is due to the fact that a higher voltage than a typical steady-state lighting voltage is typically output across the lamp output terminals at the time of starting/igniting each fluorescent lamp. This higher starting voltage when output to each fluorescent LED lamp is excessive and frequently sufficient to destroy each LED lamp in the inverter-type lighting fixture.

A ballast configuration is conventionally known that reduces costs by sharing a high frequency inverter circuit among fluorescent lamps of different types. Based upon a detected lamp current for each fluorescent lamp, a type of each fluorescent lamp is detected according to a difference in the lamp current, and the power supplied to each fluorescent lamp is controlled based on the detection result. However, this technique is not intended for and is not effective to discriminate between a fluorescent lamp and a fluorescent LED lamp.

### BRIEF SUMMARY OF THE INVENTION

The present invention makes it possible to light either a fluorescent lamp or a fluorescent LED lamp in a lighting fixture using a common ballast configuration.

According to a first aspect of the present invention, a ballast is provided for lighting a fluorescent lamp with a high frequency, the ballast being effective to detect the presence of a fluorescent LED lamp, wherein a suitable voltage for powering the fluorescent LED lamp is output from the ballast.

According to a second aspect of the present invention, the ballast includes a function of detecting the presence of the fluorescent LED lamp by applying an output voltage lower than a rated voltage of the fluorescent lamp across lamp output terminals during a predetermined time period after startup of the ballast. If the fluorescent LED lamp is not detected as being attached to the ballast in the predetermined period, the ballast performs preheating, startup and steady-state lighting operations suited for the fluorescent lamp.

According to a third aspect of the present invention, an output voltage applied across the lamp output terminals during the predetermined time period after startup of the ballast is a direct-current (DC) voltage, and the presence of the fluorescent LED lamp is detected by determining that a current is applied across the lamp output terminals as a result of applying the DC voltage.

According to a fourth aspect of the present invention, the output voltage applied across the lamp output terminals during the predetermined time period after startup of the ballast is a high-frequency voltage, and the presence of the fluorescent LED lamp is detected by determining that a current equal to or greater than a predetermined current is applied across the lamp output terminals as a result of applying the high-frequency voltage.

According to a fifth aspect of the present invention, a lighting fixture is provided including the ballast according to any of the above-described aspects of the present invention.

### BRIEF DESCRIPTION OF THE SEVERAL VIEWS OF THE DRAWINGS

FIG. 1 is a block circuit diagram showing a ballast configuration of an embodiment of the present invention.

FIG. 2 is a perspective view showing a schematic configuration of a fluorescent LED lamp employed in the present invention.

FIG. 3 is a circuit diagram showing an internal configuration of a fluorescent LED lamp employed in the present invention.

FIG. 4 is a waveform view describing an operation of the ballast of the embodiment of FIG. 1.

FIG. 5 is a circuit diagram showing a ballast configuration of another embodiment of the present invention.

FIGS. 6a-6b are waveform views describing an operation of the ballast of the embodiment of FIG. 5.

FIG. 7 is a circuit diagram showing a ballast configuration of another embodiment of the present invention.

FIGS. 8a-8b are waveform views describing an operation of the ballast of the embodiment of FIG. 7.

FIG. 9 is a circuit diagram showing a ballast configuration of another embodiment of the present invention.

FIGS. 10a-10b are waveform views describing an operation of the ballast of the embodiment of FIG. 9.

FIG. 11 is a circuit diagram showing a ballast configuration of another embodiment of the present invention.

FIG. 12 is a waveform view describing an operation of the ballast of the embodiment of FIG. 11.

FIG. 13 is a perspective view showing an external view of a lighting fixture including a ballast of the present invention.

### DETAILED DESCRIPTION OF THE INVENTION

Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in” and “on.” The phrase “in one embodiment,” as used herein does not necessarily refer to the same embodiment, although it may. The term “coupled” means at least either a direct electrical connection between the connected items or an indirect connection through one or more passive or active intermediary devices. The term “circuit” means at least either a single component or a multiplicity of components, either active and/or passive, that are coupled together to provide a desired function. The term “signal” means at least one current, voltage, charge, temperature, data or other signal. Where either a field effect transistor (FET) or a bipolar junction transistor (BJT) may be employed as an embodiment of a transistor, the scope of the terms “gate,” “drain,” and “source” includes “base,” “collector,” and “emitter,” respectively, and vice-versa.

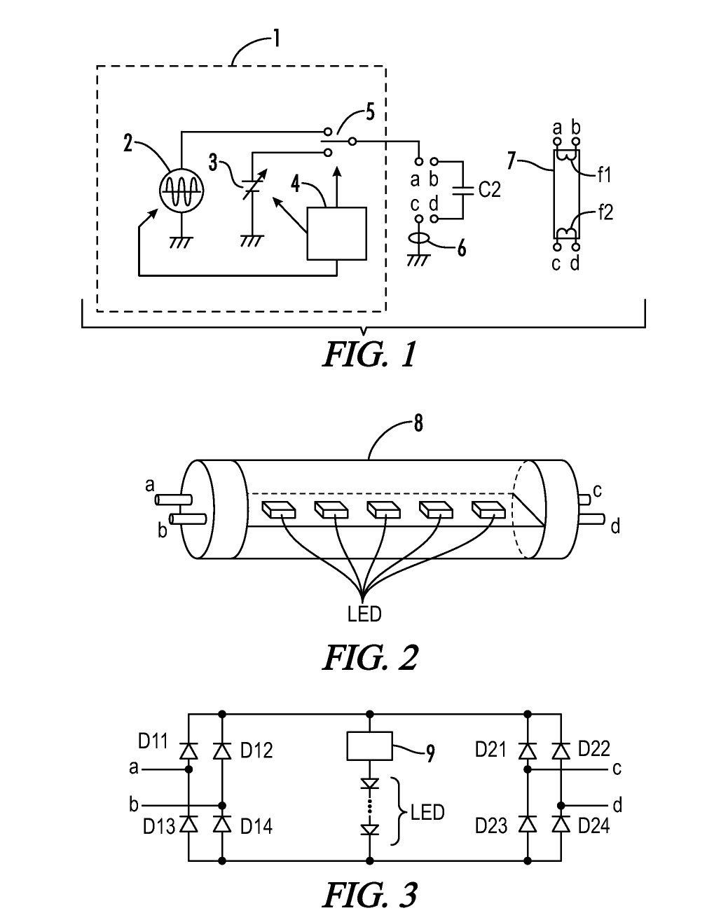

A ballast for use in a fluorescent lighting fixture and in accordance with the present invention may now be described herein with reference to FIGS. 1-13. Where the various figures may describe embodiments sharing various common elements and features with other embodiments, similar elements and features are given the same reference numerals and redundant description thereof may be omitted below.

According to various embodiments of the present invention, the ballast is effective to detect the presence of an LED lamp and, if an LED lamp is detected, output a voltage suitable for operation of the LED lamp, whereby it is possible to light not only a conventional fluorescent lamp but also the LED lamp in the fluorescent lighting fixture using an inverter-type ballast.

Referring first to FIG. 1, a ballast 1 as shown includes a high-frequency power supply 2, a direct-current (DC) power supply 3, and a lamp detection circuit 4. The high-frequency power supply 2 is provided to output a high-frequency voltage across lamp output terminals a and c. The DC power supply 3 is provided to output a DC voltage across the lamp output terminals a and c. Switching element 5 selects one of either the high-frequency power supply 2 and the DC power supply 3 according to a detection result of the lamp detection circuit 4. The lamp detection circuit 4 may activate/deactivate the high-frequency power supply 2 and the DC power supply 3 and may further adjust an output of the high-frequency power supply 2 and the DC power supply 3. During a predetermined time period (detection period) after startup of the ballast 1, the lamp detection circuit 4 selects not the high-frequency power supply 2 but the DC power supply 3, and outputs a low DC voltage across the lamp output terminals a and c. At this time, a current detection circuit 6 and the lamp detection circuit 4 may determine whether a load connected across the lamp output terminals a and c is a fluorescent lamp 7 (see FIG. 1) or a fluorescent LED lamp 8 (see FIGS. 2 and 3) by determining whether or not a current is flowing across the lamp output terminals a and c.

A fluorescent lamp 7 as shown in FIG. 1 includes filaments f1 and f2 located on both ends of a discharge tube, respectively. One filament f1 is connected across lamp output terminals a and b whereas the other filament f2 is connected across lamp output terminals c and d.

Referring now to FIGS. 2 and 3, the fluorescent LED lamp 8 as shown is configured to accommodate therein a plurality of LEDs and a lighting circuit 9, and is generally identical in shape to the fluorescent lamp 7. A series circuit of the lighting circuit 9 and the LEDs is connected to the lamp output terminals a to d via a bridge circuit including diodes D11 to D14 and a bridge circuit including diodes D21 to D24. In one embodiment, the lighting circuit 9 may be a current-limiting resistor (not shown).

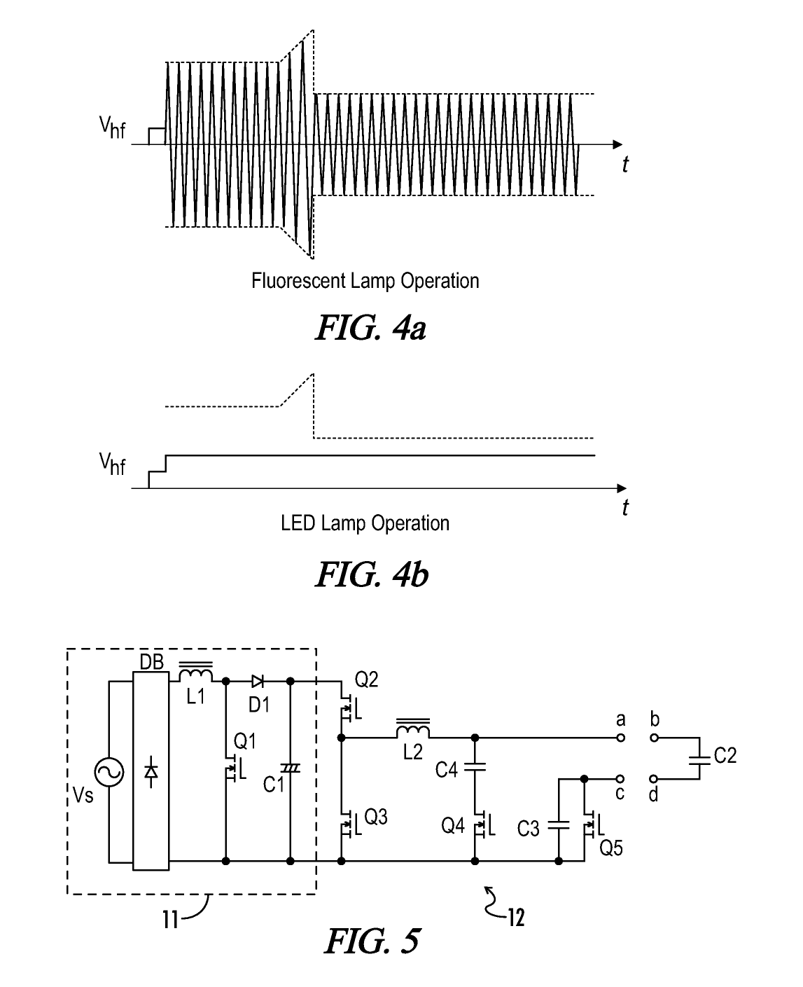

FIGS. 4a and 4b show lighting waveforms that result when the fluorescent lamp 7 and the fluorescent LED lamp 8 are coupled to the ballast 1, respectively. FIG. 4(a) shows an instance in which the fluorescent lamp 7 is connected to the ballast 1 and FIG. 4(b) shows an instance in which the fluorescent LED lamp 8 is connected thereto. In FIG. 4(b), the broken line represents the magnitude of the high-frequency voltage as if it were applied as in FIG. 4(a). It is understood that the high-frequency voltage is not applied to the fluorescent LED lamp 8 if the fluorescent LED lamp 8 is connected to the ballast 1, as opposed to the instance in which the fluorescent lamp 7 is attached to the ballast 1.

In the present embodiment, during the predetermined time period (detection period) after startup of the ballast 1, a DC voltage lower than a rated voltage of the fluorescent lamp 7 is output across the lamp output terminals a and c, and a type of the lamp may be determined. An equivalent circuit to the fluorescent LED lamp 8 is that as shown in FIG. 3. Therefore, even where the lower DC voltage than the rated voltage of the fluorescent lamp 7 is applied across the lamp output terminals a and c, a current is flowing in the detection circuit. If this current is detected, the current detection circuit 6 determines that the fluorescent LED lamp 8 is attached to the ballast 1. Thereafter, a DC voltage higher than that applied in the predetermined period after startup of the ballast 1 is output across the lamp output terminals a and c, thereby providing a sufficient output to light the fluorescent LED lamp 8.

On the other hand, in the case where the fluorescent lamp 7 is connected to the lamp output terminals a to d, a current is not flowing even when the DC voltage lower than the rated voltage is output. Therefore, the lamp detection circuit 4 can detect the type of the lamp depending on whether or not a current is flowing when the DC voltage is output.

Where the lamp detection circuit 4 does not detect the current flowing across the lamp output terminals a and c during the predetermined period after startup of the ballast 1, then the lamp detection circuit 4 determines that the fluorescent lamp 7 is connected to the ballast 1, the switching element 5 selects the high-frequency power source 2, and the ballast 1 may perform a sequence of preheating, startup and steady-state lighting operations necessary to power the fluorescent lamp 7. Specifically, the ballast 1 is controlled to apply a sufficient preheat current to the filaments f1 and f2 of the fluorescent lamp 7 while maintaining a voltage lower than a starting voltage across both ends of the fluorescent lamp 7 in a preheating period, to apply a voltage higher than the starting voltage across both ends of the fluorescent lamp 7 in a starting period, and to apply the rated voltage of the fluorescent lamp 7 across both ends of the fluorescent lamp 7 in a steady-state lighting period.

Referring now to an embodiment as shown in FIG. 5, a ballast includes a DC power supply 11 and an inverter circuit 12. The DC power supply 11 may be configured to include a rectifier circuit DB for rectifying an input signal from an alternating-current (AC) power source Vs, a step-up chopper circuit that includes an inductor L1 connected to an output of this rectifier DB, a switching element Q1 and a diode D1, and an electrolytic capacitor C1 for smoothing an output from the step-up chopper circuit. The DC power supply 11 supplies a DC voltage to the inverter circuit 12. The inverter circuit 12 is configured to include a series circuit of switching elements Q2 and Q3 that constitutes a half-bridge inverter, and a load circuit is connected across the switching element Q3.

Reference symbols a, b, c, and d denote lamp output terminals, and a voltage from the inverter circuit is applied to the lamp across the lamp output terminals a and c. A capacitor C2 is a resonant capacitor if a fluorescent lamp 7 is connected, and the capacitor C2 and an inductor L2 constitute a resonant circuit. If the fluorescent lamp 7 is connected to the lamp output terminals, a switching element Q5 coupled to a capacitor C3 is turned off, whereby the capacitor C3 acts as a DC-blocking capacitor.

A capacitor C4 operates as a smoothing capacitor if the fluorescent LED lamp 8 is connected to the lamp output terminals. A switching element Q4 serially connected to the capacitor C4 is turned on, whereby the capacitor C4 and the inductor L2 are connected across the switching element Q3, and the capacitor C4 is used as an output capacitor from a step-down chopper providing an output to each LED of the fluorescent lamp 8. In this case, at the same time, the switching element Q5 is turned on to short the DC-blocking capacitor C3 and remove that portion of the circuit.

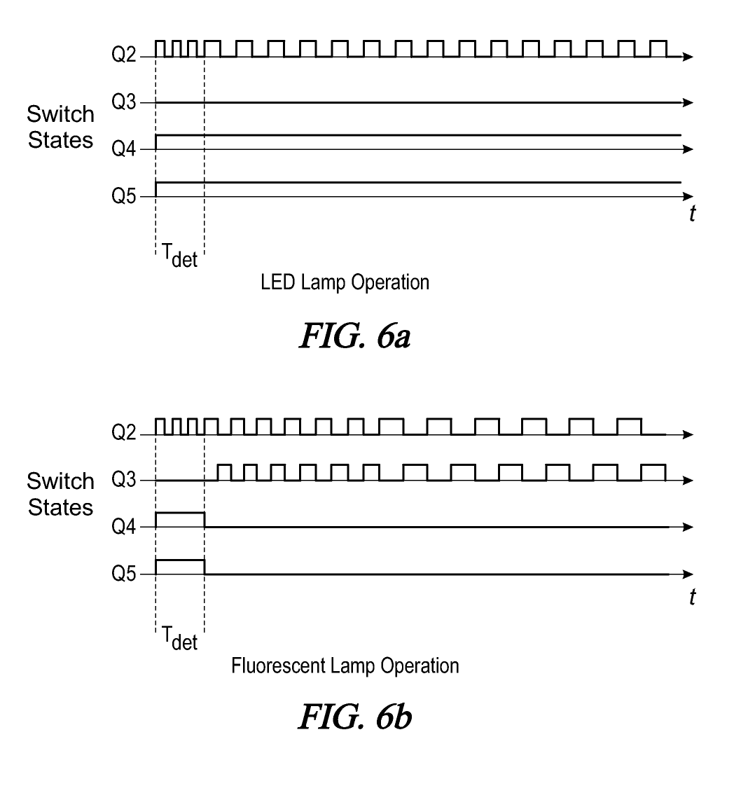

Referring now to FIGS. 6(a) and 6(b), examples of operation of a ballast as shown in FIG. 5 may be further described. FIG. 6(a) shows control signal waveforms of the switching elements Q2, Q3, Q4, and Q5 if a fluorescent LED lamp 8 is connected. FIG. 6(b) shows control signal waveforms of the switching elements Q2, Q3, Q4, and Q5 if a fluorescent lamp 7 is connected.

Referring first to FIG. 6(a), during a predetermined time period (detection period Tdet) after startup of the ballast, the switching elements Q4 and Q5 are turned on, the switching element Q3 is turned off, and the switching element Q2 is caused to alternately perform an ON or OFF operation, whereby the ballast is caused to operate as a step-up chopper. When the switching element Q2 is turned on, current flows from the capacitor C1 through the switching element Q2, to the inductor L2, through the lamp terminals a and c, to the switching element Q5, and back to the capacitor C1. In addition, current flows from the capacitor C1 to the switching element Q2, to the inductor L2, to the capacitor C4, to the switching element Q4, and back to the capacitor C1. Using the capacitor C1 as a power source, current is applied to the lamp and the capacitor C4 while storing energy in the inductor L2.

When the switching element Q2 is turned off, current discharges from the inductor L2 to the lamp (terminals a and c), through the switching element Q5, through a diode included in switching element Q3, and back to the inductor L2. In addition, current discharges from the inductor L2 through the capacitor C4, to the switching element Q4, through the diode included in switching element Q3, and back to the inductor L2. The energy stored in the inductor L2 is thereby emitted to the lamp and the capacitor C4.

Upon detecting that a current is flowing to the lamp during the detection period, it may be determined that the fluorescent LED lamp 8 is connected across the lamp output terminals a and c. An operating frequency for turning on and off the switching element Q2 may then be controlled to be appropriately lower so as to output a suitable DC voltage for the fluorescent LED lamp 8. Although a current detection circuit is not explicitly shown, it suffices to insert a current detection resistor at some location along the path of lamp current flow as known to one of skill in the art. For example, the current detection resistor may detect a voltage drop due to a resistance between a drain and a source of the switching element Q5.

Referring now to FIG. 6(b), an operation if the fluorescent lamp 7 is connected will be described. ON and OFF states of the switching elements Q2 to Q5 during the predetermined time period (detection period Tdet) after startup of the ballast are similar to those shown in FIG. 6(a).

However, if the fluorescent lamp 7 is connected, then the fluorescent lamp 7 is not ignited by an output voltage from the step-down chopper circuit, and a current is correspondingly not flowing across the lamp output terminals (a→c). Upon detection that current is not flowing during the predetermined period (detection period) after startup of the ballast, then it may be determined that the lamp is not a fluorescent LED lamp 8, and the ballast begins performing an operation for powering the fluorescent lamp 7.

Specifically, both of the switching elements Q4 and Q5 are turned off, the capacitor C4 of the step-down chopper is removed from the circuit, and the DC-blocking capacitor C3 is connected in series with the lamp output terminals. Further, an operation for alternately turning on or off the switching element Q3 to complement operation of the switching element Q2 starts. Switching frequencies of the switching elements Q2 and Q3 are appropriately reduced in each of preheating, startup and normal (steady-state) lighting operation periods, and an appropriate high-frequency voltage is output across the lamp output terminals a and c, thereby making it possible to ignite and power the fluorescent lamp 7.

In various embodiments, a period for turning on or off only one of the switching elements Q2 and Q3 constituting the half-bridge inverter is set, wherein the ballast is caused to operate as a step-down chopper to output a DC voltage across the lamp output terminals a and c. The switching element Q2 and the inductor L2 of the inverter may therefore also be used as constituent elements of the step-down chopper, making further cost reductions possible.

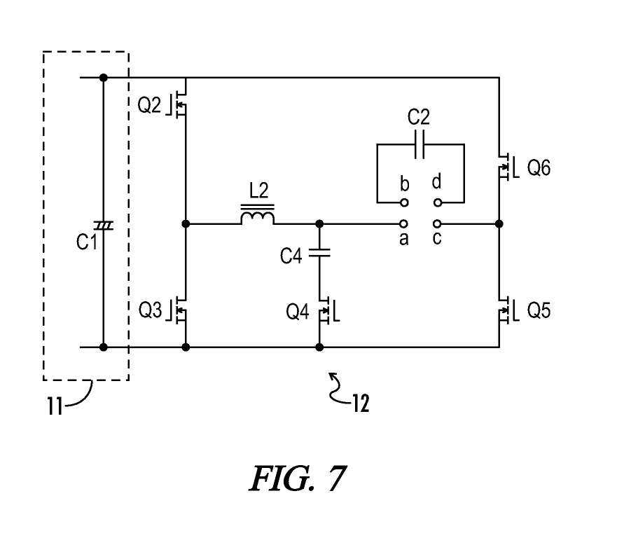

Referring now to FIG. 7, an embodiment of a ballast includes a DC power supply 11 and an inverter circuit 12. The DC power supply 11 is configured similarly to that shown in FIG. 5 and supplies a DC voltage to the inverter circuit 12. The inverter circuit 12 shown is a full-bridge inverter configured to connect a first series circuit of switching elements Q2 and Q3 to a second series circuit of switching elements Q6 and Q5 coupled in parallel with the first series circuit. A series circuit of a capacitor C4 and a switching element Q4 is coupled across the switching element Q3 via the inductor L2. By turning on the switching element Q4, the capacitor C4 can operate as an output capacitor of a step-up chopper.

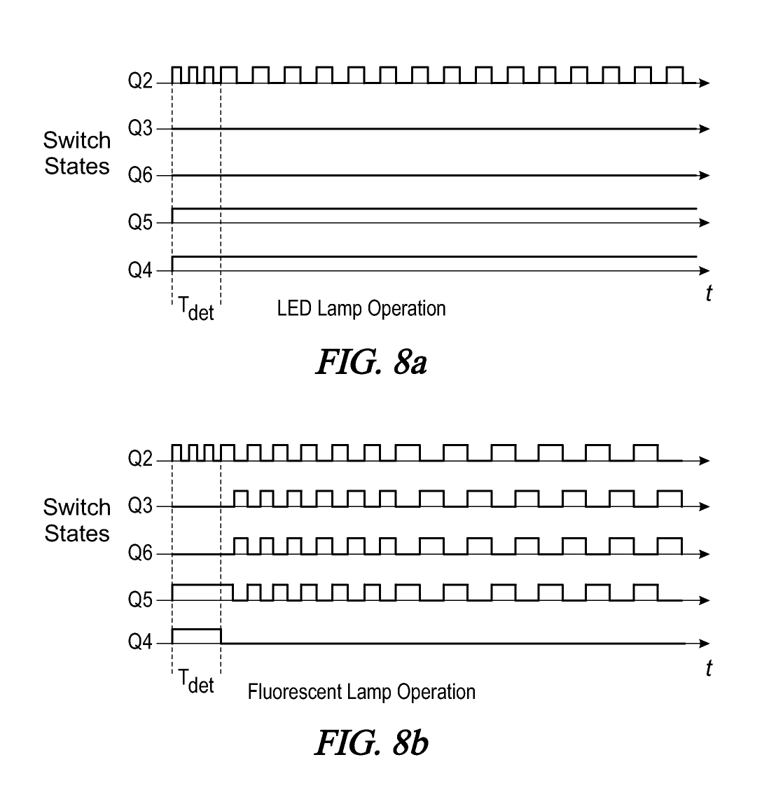

FIG. 8 shows operation waveforms according to various embodiments of the ballast shown in FIG. 7. FIG. 8(a) shows control signal waveforms of the switching elements Q2, Q3, Q4, Q5, and Q6 if a fluorescent LED lamp 8 is connected. FIG. 8(b) shows control signal waveforms of the switching elements Q2, Q3, Q4, Q5, and Q6 if the fluorescent lamp 7 is connected.

Referring to FIG. 8(a), an operation if the fluorescent LED lamp 8 is connected will be described. During a predetermined time period (detection period Tdet) after startup of the ballast, the switching elements Q5 and Q4 are turned on, the switching elements Q3 and Q6 are turned off, and the switching element Q2 is caused to alternately switch ON and OFF. A step-down chopper is formed by the resulting circuit configuration, wherein a constant output voltage is applied to the capacitor C4 and the lamp (a→c), and a current flow is applied to the fluorescent LED lamp 8. Upon detection that the current is flowing to the fluorescent LED lamp 8 during a predetermined time period (detection period) after startup of the ballast, it may be thereby determined that the fluorescent LED lamp 8 is connected. Thereafter, a frequency for operation (turning on and off) of the switching element Q2 is controlled to be appropriately lower so as to output a suitable voltage for the fluorescent LED lamp 8 after the end of the detection period.

Referring to FIG. 8(b), an operation if the fluorescent lamp 7 is connected will be described. ON and OFF states of the switching elements Q2 to Q6 during the predetermined time period (detection period Tdet) after startup of the ballast are similar to those shown in FIG. 8 (a). However, if the fluorescent lamp 7 is connected, then the fluorescent lamp 7 will not be ignited by the output voltage from the step-down chopper during the detection period, and a current is correspondingly not flowing across the lamp output terminals (a→c). Upon detection that the current does not flow during the predetermined time period (detection period) after startup of the ballast, it may then be determined that the lamp is not the fluorescent LED lamp 8, and the ballast begins performing an operation for powering the fluorescent lamp 7.

In various embodiments according to this method of operation, the switching elements Q2 and Q5 may be turned on or off synchronously, and the switching elements Q3 and Q6 may be turned on or off synchronously in a phase inverted from that of the switching element Q2, whereby the ballast operates as a full-bridge inverter. At this time, the switching element Q4 is turned off, thereby removing the capacitor C4 from the load circuit.

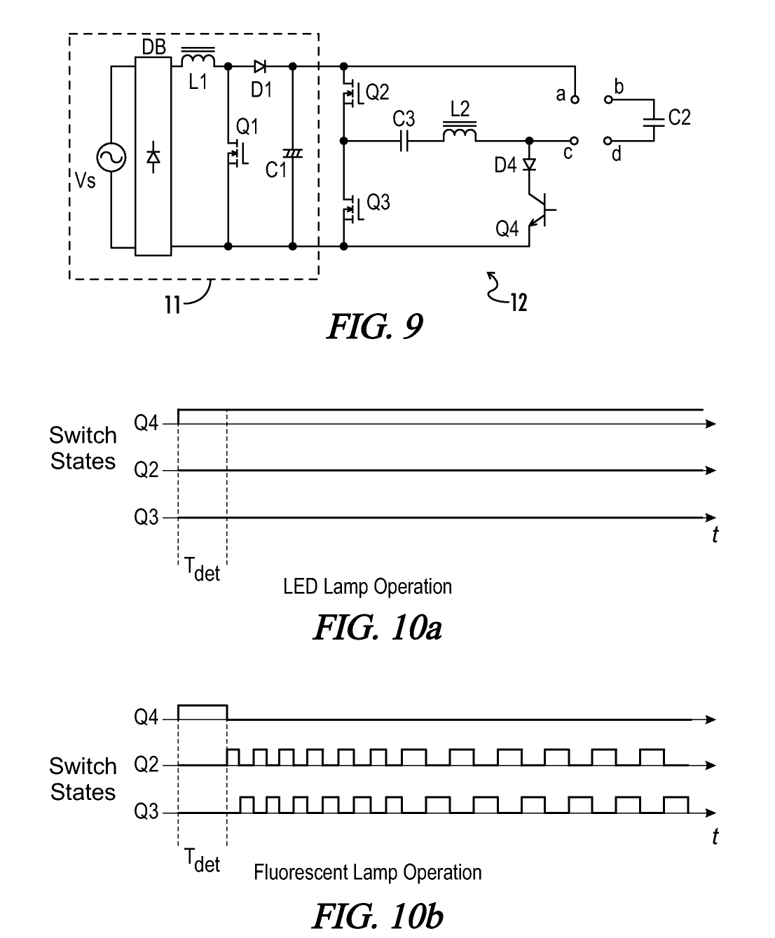

Referring now to FIG. 9, an embodiment of a ballast includes a DC power supply 11 and an inverter circuit 12. The DC power supply 11 is configured similarly to that shown in FIG. 5 and supplies a DC voltage to the inverter circuit 12. The inverter circuit 12 includes a series circuit of switching elements Q2 and Q3, a DC-blocking capacitor C3 connected to a connection point between the switching elements Q2 and Q3, and the inductor L2 for resonance and current-limiting. The inverter circuit 12 uses a positive (+) terminal a of the DC power supply 11 and a terminal c of the inductor L2 as lamp output terminals, and the resonant capacitor C2 is connected across lamp output terminals b and d opposite the power source. If the load is a fluorescent lamp 7 (see FIG. 1), filaments f1 and f2 are connected across the terminals a and b and the terminals c and d, respectively. A configuration of the inverter circuit 12 as stated above may be similar for example to that of an ordinary capacitor preheating half-bridge inverter.

In embodiments as shown, a series circuit of a diode D4 and a switching element Q4 is further provided between the terminal c of the inductor L2 and a negative (−) terminal of the DC power supply 11. By turning on the switching element Q4, the lamp output terminals (a→c) are connected across the capacitor C1, and a DC voltage is output. Although a current detection circuit is not explicitly shown, it would be well known to one of skill in the art to insert as but one example a current detection resistor somewhere in a route of lamp current flow to detect the type of lamp that may or may not be connected to the ballast circuit based on the detected signal across the lamp output terminals. For example, the current detection resistor may detect voltage between a collector and an emitter of a bipolar transistor that is the switching element Q4 by turning on the bipolar transistor in an unsaturated zone.

FIG. 10 shows operation waveforms for various embodiments such as shown in FIG. 9. FIG. 10(a) shows control signal waveforms of the switching elements Q2, Q3, and Q4 if a fluorescent LED lamp 8 is connected. FIG. 10(b) shows control signal waveforms of the switching elements Q2, Q3, and Q4 if the fluorescent lamp 7 is connected.

Referring to FIG. 10(a), an operation if the fluorescent LED lamp 8 is connected will first be described. During a predetermined time period (detection period Tdet) after startup of the ballast, only the switching element Q4 is turned on, and the switching elements Q2 and Q3 are turned off. The DC voltage generated in the capacitor C1 is thereby output to the lamp terminals (a→c). Because current is flowing to the lamp output terminals by this DC voltage, it is possible to detect that the fluorescent LED lamp 8 is connected. In this case, a step-up chopper of the DC power supply 11 preferably outputs a voltage lower than a voltage at which the fluorescent lamp 7 operates for the following reason. Because an ordinary voltage output from the step-up chopper is effectively about twice as high as a commercial AC voltage, this output voltage is often excessively high for the fluorescent LED lamp 7 and may cause undesirable damage. Alternatively, step-up chopper operation may be stopped only during the predetermined period (detection period Tdet) after startup of the ballast and in an instance subsequent to the detection period, in which the connected lamp is detected as the fluorescent LED lamp 8.

Referring to FIG. 10(b), an operation is described for the case where the fluorescent lamp 7 is connected. ON and OFF states of the switching elements Q2 to Q4 during the predetermined period (detection period Tdet) after startup of the ballast are similar to those shown in FIG. 10(a). However, if the fluorescent lamp 7 is connected, then the fluorescent lamp 7 may not be ignited by the DC voltage from the capacitor C1, and a current is correspondingly not detected as being applied across lamp output terminals (a→c). After the end of the detection period, the switching element Q4 is turned off to disconnect the lamp output terminal c from the capacitor C1, a high-frequency voltage is output to the lamp output terminals a and c by a half-bridge inverter operation for alternately turning on and off the switching elements Q2 and Q3, and preheating, startup, and normal (steady-state) operating periods are conducted, respectively.

Specifically, during the preheating period, the switching elements Q2 and Q3 are alternately turned on and off with a frequency sufficiently higher than a no-load resonance frequency of the inductor L2 and the capacitor C2, thereby providing a high-frequency output voltage lower than a starting voltage for igniting the fluorescent lamp 7 across the lamp output terminals a and c. As a result, a preheat current is applied to the fluorescent lamp 7 via a pair of filaments f1 and f2 (see FIG. 1) and the capacitor C2, to transform the fluorescent lamp 7 into a state in which thermo-electrons can be emitted. Next, in the lamp startup period, the switching elements Q2 and Q3 are alternately turned on and off with a frequency close to the no-load resonance frequency of the inductor L2 and the capacitor C2, thereby providing a high-frequency output voltage higher than the starting voltage for igniting the fluorescent lamp 7 across the lamp output terminals a and c. As a result, the fluorescent lamp 7 is ignited. Thereafter, in the normal lighting (steady-state) period, the switching elements Q2 and Q3 are alternately turned on and off with an appropriate frequency (phase delay mode) higher than a lighting resonance frequency of the inductor L2 and the capacitor C2 according to a load impedance of the fluorescent lamp 7, thereby providing a high-frequency output voltage corresponding to the rated voltage for the fluorescent lamp 7 across lamp output terminals a and c. As a result, it is possible to normally light the fluorescent lamp 7 in a rated state. The operations in the preheating, startup, and steady-state lighting periods apply for the other embodiments as previously described.

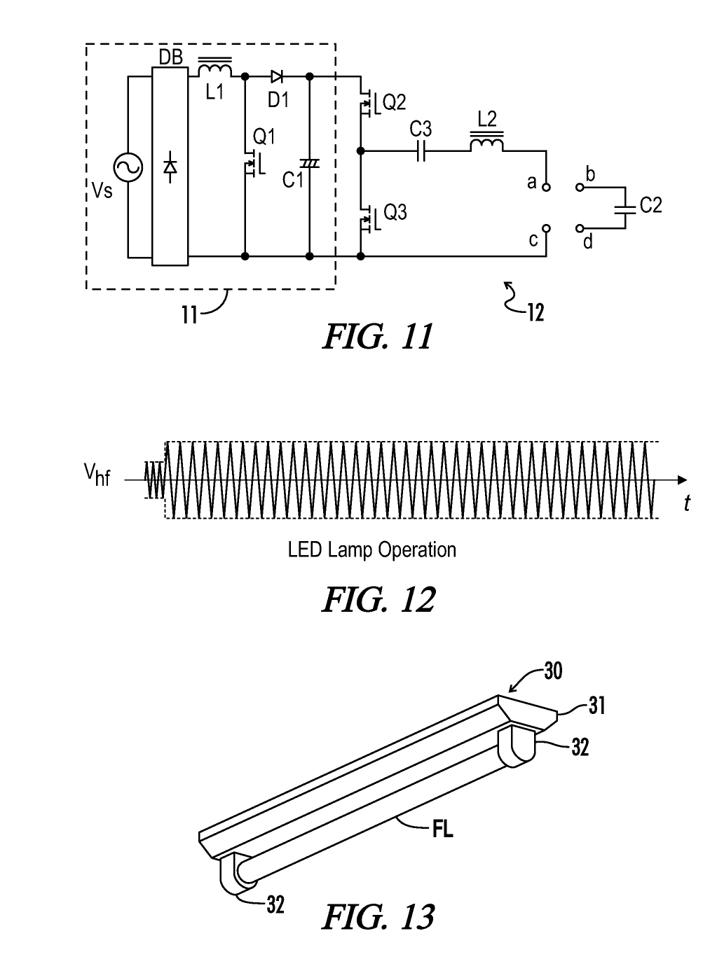

Referring now to FIG. 11, an embodiment of a ballast includes an ordinary half-bridge inverter, and is configured not to apply a DC voltage across lamp output terminals a and c during a predetermined period (detection period) after startup of the ballast, but to set an output voltage in an inverter operation to a low voltage (for example, high-frequency voltage lower than a voltage in a preheating period).

Referring to FIG. 12, an operation waveform is shown of a voltage applied across lamp output terminals a and c if the fluorescent LED lamp 8 is connected to a ballast in various embodiments as shown for example in FIG. 11. Even if the fluorescent lamp 7 (see FIG. 1) is connected, current flows from terminal a to the filament f1, to the terminal b, through the resonant capacitor C2, to the terminal c, to the filament f2, and to the terminal d. However, current flowing along this route is low because an output voltage in the detection period is lower than that in a preheated state.

If the fluorescent LED lamp 8 is connected, a current flows directly from the lamp output terminals (a→c) to the fluorescent LED lamp 8. Therefore, compared with the fluorescent lamp 7, the current is high. Depending on a difference in a magnitude of this current value, it is possible to determine whether the lamp is the fluorescent lamp 7 or the fluorescent LED lamp 8.

Where it is determined that the fluorescent LED lamp 8 is connected, a switching frequency of the inverter circuit 12 is adjusted so as to output an AC voltage suitable for the fluorescent LED lamp 8. On the other hand, if it is determined that the fluorescent lamp 7 is connected, the ballast performs an ordinary inverter ballast sequence of preheating, startup, and steady-state lighting operations.

Referring to FIG. 13, an external view is shown of a lighting fixture mounting the discharge lamp ballast according to various embodiments of the present invention. A lighting fixture 30 includes a fixture main body 31 incorporating therein the ballast, and a pair of sockets 32 for electrically connecting the ballast to a lamp FL. Electrodes of the lamp FL are detachably attached to the sockets 32, respectively. As the lamp FL, either the fluorescent lamp 7 (see FIGS. 1 to 7) or the fluorescent LED lamp 8 (see FIGS. 2 and 3) can be used. While FIG. 13 shows a straight tube fluorescent lamp as the fluorescent lamp, it is of course foreseeable that a round fluorescent lamp may be applied as well.

Thus, although there have been described particular embodiments of the present invention of a new and useful Adjustable Output Ballast for Powering Both Fluorescent Lamps and LED Lamps, it is not intended that such references be construed as limitations upon the scope of this invention except as set forth in the following claims.

What is claimed is:

1. A ballast for powering a fluorescent lamp and an LED lamp, the ballast comprising:
a power supply circuit;
a pair of switching elements connected in series and coupled across the power supply circuit;
a pair of lamp output terminals coupled to the pair of switching elements;
the power supply circuit and the switching elements are configured to provide a first output signal across the lamp output terminals during a predetermined time period after startup of the ballast;
the power supply circuit and the switching elements are further configured to provide a second output signal after the predetermined time period, the second output signal dependent upon a detected lamp current during the predetermined time period; and
wherein the detected lamp current in a first condition determines the presence of a fluorescent lamp and the detected lamp current in a second condition determines the presence of an LED lamp.

2. The ballast of claim 1 further comprising:
the power supply circuit comprising a DC power supply;
the first output signal across the lamp output terminals comprises a DC signal;
the second output signal comprises the DC signal upon detection of a current across the lamp output terminals during the predetermined time period;
the second output signal comprises an AC signal when the current is not detected; and
the switching elements are configured to convert the DC signal into the AC signal across the lamp output terminals when the current is not detected.

3. The ballast of claim 2, wherein the DC signal is lower than a rated voltage for igniting the fluorescent lamp.

4. The ballast of claim 3, wherein upon not detecting the current during the predetermined period after startup of the ballast, the power supply and switching elements are further configured to controllably output AC signals across the lamp terminals for preheating of the fluorescent lamp, igniting the fluorescent lamp, and operating the fluorescent lamp in steady-state.

5. The ballast of claim 1 further comprising:
the power supply circuit comprising a DC power supply configured to supply a DC output signal;
the switching elements are configured to convert the DC output signal into a high-frequency AC signal across the lamp output terminals; and
wherein the first output signal comprises a high-frequency AC voltage less than a rated voltage for igniting the fluorescent lamp.

6. The ballast of claim 5 further comprising:
the second output signal comprises an AC signal suitable for powering an LED lamp provided across the lamp output terminals after the predetermined time period, upon detection of a current across the lamp output terminals during the predetermined time period greater than a predetermined current value;
and the second output signal comprises an AC signal suitable for powering a fluorescent lamp provided across the lamp output terminals after the predetermined time period, when the detected current is less than the predetermined current value.

7. A ballast having a first and second lamp output terminals and configured for powering a lamp coupled across the terminals, the ballast comprising:
a first power supply configured to supply a high-frequency AC voltage;
a second power supply configured to supply a DC voltage;
a switching element coupled to the first lamp output terminal, and configured to controllably apply the AC voltage or the DC voltage to a lamp coupled across the lamp output terminals; and
a lamp detection circuit coupled to the second lamp output terminal, and configured to control the switching element dependent upon a detected current across the lamp output terminals during a predetermined time period after startup of the ballast.

8. The ballast of claim 7, wherein the switching element is controlled to apply DC voltage across the lamp output terminals during the predetermined time period.

9. The ballast of claim 8, wherein upon detection of a current across the lamp output terminals during the predetermined time period, an LED lamp is determined to be coupled across the lamp output terminals, and wherein the switching element is controlled to apply DC voltage across the lamp output terminals after the predetermined time period.

10. The ballast of claim 9, wherein upon not detecting of a current across the lamp output terminals during the predetermined time period, a fluorescent lamp is determined to be coupled across the lamp output terminals, and wherein the switching element is controlled to apply a high-frequency AC voltage across the lamp output terminals after the predetermined time period.

11. The ballast of claim 10, the first power supply configured to provide AC voltages having values for preheating the fluorescent lamp, igniting the fluorescent lamp, and operating the fluorescent lamp in steady-state.

12. The ballast of claim 10, the DC voltage applied across the lamp output terminals during the predetermined time period having a value less than a rate voltage for igniting of the fluorescent lamp.

13. The ballast of claim 12, the DC voltage applied across the lamp output terminals during the predetermined time period having a value less than a DC voltage applied across the lamp output terminals after the predetermined time period when an LED lamp is detected.

14. The ballast of claim 7, further comprising a current detection circuit coupled to the second lamp output terminal, the lamp detection circuit configured to control the switching element based on an output from the current detection circuit.

15. The ballast of claim 14, the current detection circuit further comprising a current detecting resistor.

16. A method for powering either of a fluorescent lamp or an LED lamp with a common ballast configuration, the ballast comprising a power supply and a pair of switching elements connected in series and coupled across an output end of the power supply, the method comprising the steps of:
providing a voltage across a pair of lamp output terminals coupled to the switching elements during a predetermined time period after startup of the ballast;
detecting a current condition across the pair of lamp output terminals during the predetermined time period;
based on a first detected current condition wherein a fluorescent lamp is determined to be connected to the ballast, providing a first voltage across the lamp output terminals suitable for powering the fluorescent lamp after the predetermined time period; and
based on a second detected current condition wherein an LED lamp is determined to be connected to the ballast, providing a second voltage across the lamp output terminals suitable for powering the LED lamp after the predetermined time period.

17. The method of claim 16, wherein the voltage provided during the predetermined time period after startup of the ballast is less than a rated voltage effective to ignite the fluorescent lamp.

18. The method of claim 17, wherein the voltage provided during the predetermined time period after startup of the ballast is a DC voltage,
wherein the first detected current condition is that no current is detected across the lamp output terminals, and
wherein the second detected current condition is that a current is detected across the lamp output terminals.

19. The method of claim 18, wherein providing a first voltage across the lamp output terminals suitable for powering the fluorescent lamp after the predetermined time period further comprises providing a high-frequency AC voltage having a plurality of operating values effective to preheat, to ignite and to operate the fluorescent lamp in steady-state.

20. The method of claim 17, wherein the voltage provided during the predetermined time period after startup of the ballast is a high-frequency AC voltage,
wherein the first detected current condition is that a current less than a predetermined current value is detected across the lamp output terminals, and
wherein the second detected current condition is that a current greater than a predetermined current value is detected across the lamp output terminals.
